(19) United States
(12) Patent Application Publication
(10) Pub. No.: US 2005/0064866 A1
(43) Pub. Date: Mar. 24, 2005

(54) Combined long and short distance wireless communication system and its method

(75) Inventors: Guobin Sun, Beijing (CN); Zifeng Hou, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Lenovo (Beijing) Limited, ict (CN)

(21) Appl. No.: 10/500,492

(22) PCT Filed: Dec. 25, 2002
(86) PCT No.: PCT/CN02/00914

(30) Foreign Application Priority Data
Dec. 29, 2001 (CN) 01130242.9

(51) Int. Cl. H04B 7/00; H04Q 7/20; H04M 1/00

(52) U.S. Cl. 455/426.1; 455/41.2; 455/553.1

(57) ABSTRACT

This invention provides a combined long and short distance wireless communication system and method thereof. A dual distance terminal provides subscribers with the long and short distance wireless communication service and guarantees that the service isn't interrupted when switching between different networks occurs. A remote distance base station provides the dual distance terminal with remote distance wireless access. A short distance AP provides the dual distance terminal with short distance wireless access. A dual distance network server connects the remote distance base station and the short distance AP to switch between networks and make the dual distance terminal access the network to which is switched. The present invention enables the dual distance terminal within the coverage of the long and short distance wireless system to communicate with the long distance networks and automatically switch to short distance wireless local area networks (WLAN) when the dual distance terminal enters the short distance WLAN so that seamless switch is achieved. The subscribers having different priority levels access different short distance WLANs with different levels after authority identification.

### BACKGROUND OF THE INVENTION

1. Field of the Invention

This invention relates to a wireless communication system and its method, more specially, to a wireless communication system which combines long and short distance wireless communication techniques and achieves seamless switch of links. This invention belongs to the field of communication techniques.

2. Background of Prior Art

In current mechanisms of communication systems, GSM/GPRS and the future 3G (third generation) are all long distance communication (LDC). The major characteristics for long distance communication include the coverage of large area, installation with low cost, and operation with high cost and low transmission rate, etc. The long distance communication can be referred as to a concept of “ocean”. Recent 802.11 and BT, for example, belong to the short distance communication (SDC). The major characteristics of short distance communication include the use in office areas and certain business areas, the coverage of limited areas, installation with high cost, operation with low cost and high transmission rates, etc. The short distance communication can also be referred as to a concept of “island”. The networks of the short distance communication are separated from each other, and have been significantly limited to a certain area respectively.

In GSM900/1800 networks, and the interacting networks of GSM/GPRS and the third generation mobile communication, all of them embody the concept of long distance, i.e. the concept of “ocean”. The operation modes employed are multiple access modes such as TDMA, CDMA. However, in long and short distance communication networks, short distance communication generally employs operation modes such as CSMA/CA which are suitably used for short distance transmission. Meanwhile, in long distance communication networks (LDCN), although the transmission powers thereof are always very large, the transmission powers are limited due to the limitation of Local Area Networks (LAN) such as WLAN networks, so that the characteristics of “island” is present. Furthermore, with respect to long distance communication networks, short distance communication networks (SDCN) have the advantages of wide bands, fast transmission rates, low cost etc.

There exists a need to combine long distance communication networks and short distance communication networks to complement the advantages for each other. Thus, a terminal can receive the services from long and short distance communication networks according to different requests. For example, the terminal may obtain a voice service with long distance communication networks whereas obtain a data service with short distance communication networks. That is, in long and short distance communication networks, the characteristics of that short distance communication is present in long distance communication network coverage.

### SUMMARY OF THE INVENTION

An object of the present invention Is therefore to provide a wireless communication system and method which can combine long and short distance communication techniques.

Another object of the present invention is to provide a wireless communication dual distance terminal which can combine long and short distance communication techniques.

Yet another object of the present invention is to provide a wireless communication dual distance network server which can combine long and short distance communication techniques.

The present invention may achieve seamless switch such as automatic switching, capacity evaluation and security issues and the likes when a user enters an area covered by both long and short distance wireless communication while guarantee the long distance wireless communication so that the user may use short distance wireless communication and access whole networks through the short distance wireless access point (AP), Thus, the two types of network resources can be more effectively used.

To achieve above objects of the prevent invention, according to one aspect of the present invention, a combined long and short distance wireless communication system comprises: a dual distance terminal for providing subscribers with long and short distance communication services, at least one remote distance base station for providing remote distance wireless access for the dual distance terminal, at least one short distance access point (AP) for providing short distance wireless access for the dual distance terminal, and a dual distance network server for connecting the remote distance base station through the short distance AP to execute network switching for the dual distance terminal and enabling the dual distance terminal to access the network to which it is switched.

According to another aspect of the present invention, a wireless communication method using combined long and short distance wireless communication systems, comprising steps of scanning a dual distance terminal to determine whether it is located in a service area covered by a short distance access point upon powering on; entering a short distance communication network through the short distance access point if the dual distance terminal is located within the service area covered by the short distance access point, and informing a dual distance home server of the position of the dual distance terminal; searching for a base station for a long distance communication service if the dual distance terminal is not located in the area covered by any one of the short distance access points, entering a long distance communication network through a long distance access network, and informing the dual distance home server of the position of the dual distance terminal.

According to yet another aspect of the present invention, a dual distance network server used for a combined long and short distance wireless communication system, comprising:
a data service function entity for detecting whether a long and short distance data transmission occurs, if it occurs, then providing a connection service for said data transmission;
a memory function entity for storing data that may be missed at the time of memory switching, and sending the stored data to a terminal via said data service function entity after said terminal switching is completed, in order to implement seamless switch for the terminal between a long distance communication network and a short distance communication network;
a dual distance home server for registering the dual distance character parameters of the dominated dual distance terminals, obtaining terminal switch information via said data service function entity when dual distance switch occurs, updating the terminal data; and informing said data service function entity of terminal-related dual distance information when a query regarding the terminal exists;
an external network interface unit for connecting dual distance network and an interface of external networks.

For the dual distance terminal of the invention, it has to adapt configuration of both the long distance and short distance communication networks so that the dual distance terminal may move in both networks, the dual distance terminal comprises:
a short distance communication function entity having a short distance radio frequency function module for functioning as physical layer, part of MAC layer or link layer and operating in a short distance communication network to obtain data information;
a long distance communication function entity having a long distance radio frequency function module for functioning as physical layer and part of link layer;
a network switch condition judging function entity for performing network switching for the dual distance terminal based on the corresponding dual distance switch condition judging and instructing the short distance communication function entity or the long distance communication function entity to send a beacon signal to the dual distance network server;
a common function entity for implementing display and input and output functions of the terminal.

The combination of long and short distance wireless communication according to the invention brings a lot of convenience, and changes the status of separation of the architectures of long distance and short distance radically. The present invention has the advantages as follows:
at any time, a real-time transmission may be achieved by the long distance wireless communication:
when a mobile terminal is allowed to enter the short distance wireless LAN, it can automatically switching to the short distance communication mechanism with priority, and the transmitting traffic stream of the subscriber would not be interrupted so that seamless switch can be achieved;
when the mobile terminal move out the short distance wireless LAN, It can automatically switch to the long distance communication network, and the transmitting traffic stream for the subscriber would not be interrupted so that seamless switch can be achieved;
when the other subscriber terminal in the system according to the invention is calling and querying any one of the terminal allowed to be accessed, the system according to the invention may guarantee the subscriber could be accessed either in the short distance communication LAN or in the short distance communication network.

### BRIEF DESCRIPTION OF THE DRAWINGS

Above and/or other objects and advantages of the present invention will become apparent and more readily appreciated from the following description of the embodiments, taken in conjunction with the accompany drawings of which:

FIG. 1 is a schematic diagram showing the structure of according to an embodiment of the present invention.

FIG. 2 is a flow chart showing the operation according to the embodiment of the invention.

FIG. 3 is a schematic diagram showing the structure of the dual distance communication network server function module of the invention.

FIG. 4 is a flow chart when the dual distance communication network server performs switching.

FIG. 5 is a schematic diagram showing the structure of the dual distance terminal according to the invention.

### DETAILED DESCRIPTION OF PREFERRED EMBODIMENTS

The present invention constructs a wireless communication system as a structure of “ocean+island”. According to the wireless communication system of the present invention, remote distance base stations cover all the effective areas; short distance access points (AP) cover areas such as offices, residents, and business areas which subscriber density is relatively high. A long and short distance communication server connects the short distance APs with the remote distance base stations. A plurality of dual distance terminals may freely move within the all areas covered by the short distance APs and the remote distance base stations.

The Operation Principle of the Present Invention

When a dual distance terminal is powered on, first, it detects whether it is located in the service area covered by a certain short distance AP. If it is yes, then the dual distance terminal accesses the network through the short distance AP, and informs a dual distance home server of the position thereof. If the dual distance terminal is not within the area covered by any one of the short distance APs, then it searches for a base station for a long distance communication service, accesses network through the remote distance base station, and Informs the dual distance home server of position thereof.

When a dual distance terminal located in the long distance communication network enters any one of the service areas covered by the short distance APs, the dual distance terminal will detent the short distance AP. If the short distance signal thereof is above a predetermined threshold, the dual distance terminal will automatically switch to short distance communication frequency band, and begin to access the network via the short distance AP. The data transmission carried out by the long distance communication network is then carried out by the short distance communication network to achieve seamless switch. Further, the terminal informs its home server of the area which it locates now. The server Is in charge of the query and communication to the terminal from other terminals in the network.

When a dual distance terminal located in the short distance communication networks moves out of the service area covered by the short distance communication networks and enters the long distance network, the terminal detects the short distance AP signal. If the short distance signal thereof is below a predetermined threshold, the dual distance terminal automatically switches to the long distance network. The data transmission carried out by the short distance is then carried out by the long distance network to achieve seamless switch. Then, the terminal informs its home server that it has already located in the area covered by the long distance network. After that, the server is in charge of the query and communication to the terminal from other terminals in the network.

When a dual distance terminal located in the long distance networks requests to enter any one of the service areas of the short distance APs, if the AP in the area in which the terminal locate rejects the access of dual distance terminal due to security or other issues, the dual distance terminal then still keeps the long distance communication.

When a dual distance terminal moves from one short distance cell to another short distance cell, the dual distance terminal identify the area, into which the dual distance terminal will enter, covered by the short distance AP. Then the dual distance terminal transmits information of the corresponding cell to the dual distance communication network server so as to achieve the switching between the short distance cells. After that, the dual distance terminal informs the home server among the dual distance network communication servers that it has already been enter into the area covered by another short distance communication network. The home server is then in charge of the queries and communications to the dual distance terminal from the other terminals in the networks.

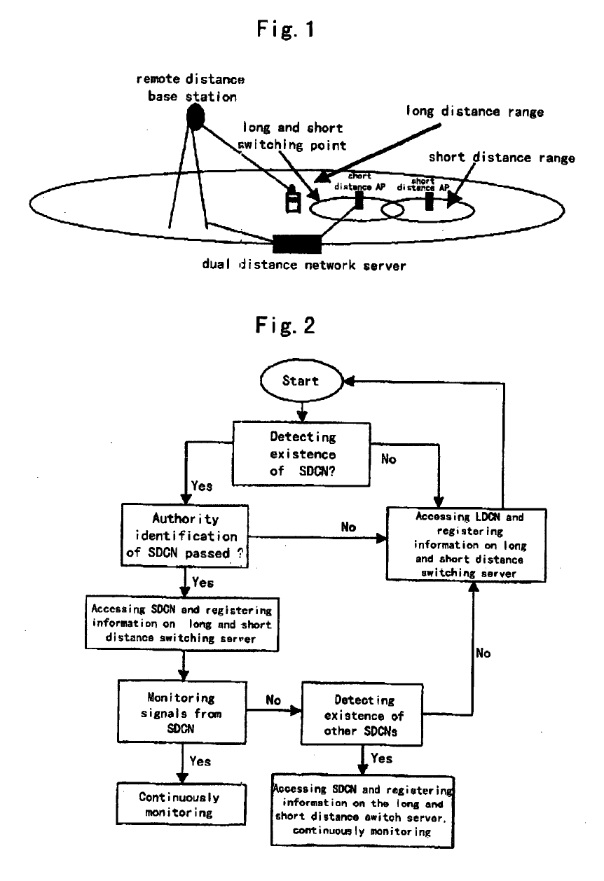

The invention will be described by using a combined dual distance wireless communication system which is formed by combining a long distance GSM/GPRS with a short distance WLAN by way of example. The network architecture of the wireless communication system according to the invention comprises GSM/GPRS base stations, a long distance access related network function entity, wireless LAN APs, a short distance access related network function entity, a dual distance communication network server for linking the long distance GSM/GPRS networks and the short distance wireless LANs, dual distance terminals compatible with long distance communication network and short distance communication network. FIG. 1 shows the basic network structure of the invention. However, it should be noted that the present invention is not limited to the example shown as FIG. 1, it may include a combined architecture formed by combining a long distance 3G communication with a short distance WLAN or a combined architecture of other long distance and short distance communication modes.

Now referring to FIGS. 1 and 2, the operation of a dual distance communication network formed by combining GSM/GPRS with WLAN according to an embodiment of the invention will be described in more detail.

1. In the Dual Distance Network, After the Dual Terminal Powered On.

For the system described in the invention, the dual terminal automatically searches for the network environment currently located after it is powered on by the subscriber. If the dual distance terminal detects that a wireless local area network WLAN network exists and does not require authority identification at present, the dual distance terminal then accesses the WLAN network directly. On the contrary, if the result of the detection indicates that current WLAN network requires authority identification, the dual distance terminal then performs access authority identification via WLAN. If the authority identification is successful, the dual distance terminal accesses current WLAN network. Otherwise, the dual distance terminal will continue the detection and enter into the long distance GPRS communication network.

After the dual distance terminal enters into the WLAN network, the dual distance terminal may perform data transmission by accessing the dual distance communication server via the short distance WLAN network.

2. Switching Between Networks

2.1 Switching From the Short Distance WLAN Communication Networks to the Long Distance GPRS Communication Networks

When the dual distance terminal moves out of the short distance WLAN network and enter into the GPRS network, the dual distance terminal may make judgment by using a predetermined switching condition. If a predetermined threshold for switching (which may refer to a non-usable threshold of a short distance communication network signal or may refer to a non-optimal threshold of a short distance communication network signal) is satisfied, the dual distance terminal terminates data transmitted through the WLAN radio frequency function entity (not shown) with the predetermined switching condition, and activates the long distance communication function entity and uses it to implement the possible sequent data transmission. If the service level of this dual distance terminal requires a seamless switching, then the dual distance terminal terminates the data being transmitted by the WLAN radio frequency function entity. At the same time, it sends beacon signal for switching between the shot distance communication network and the long distance communication network to the short distance AP, from which the communication is switched, by the short distance communication function entity in the terminal. The beacon signal is transmitted to the dual distance communication network server by the short distance AP. After receiving the corresponding beacon signal, the dual distance network server informs the long distance communication function entity to be accessed by the dual distance terminal of the receipt, and determines the service queue position which the dual distance terminal is arranged in the long distance network function entity (provided in the dual distance network server, not shown) based on its service level.

Meanwhile, the dual distance communication network server stores the data packets which may be missed in the switching process to protect the data packets, the stored data packets are forwarded to the dual distance terminal after the switching is completed, thereby preventing data for the dual distance terminal from lost during the switching.

2.2 Switching From the Long Distance GPRS Networks to the Short Distance WLAN Networks

When the dual distance terminal moves out of the long distance GPRS network and enters into the short distance WLAN network, the dual distance terminal may make judgment by using switching condition. If the predetermined threshold for switching is satisfied, the dual distance terminal terminates the data transmitted through the long distance communication function entity with the predetermined switching condition, and activates the short distance communication function entity and uses it to implement the possible sequent data transmissions.

When terminating the data being transmitted by the long distance communication function entity, the dual distance terminal further sends one beacon signal of long and short distance switching to the GPRS service function entity, from which switch is performed, by the base station and the corresponding GPRS network function entity in the dual distance terminal. The beacon signal is transmitted to the dual distance network server by the GPRS function entity. After receiving the corresponding beacon signal, the dual distance network server informs the short distance communication function entity of the receipt, and determines the priority of the dual distance terminal in the short distance communication network function entity based on its service level.

Meanwhile, the dual distance communication network server stores the data packets which may be missed in the switching process to protect the data packets, the stored data packets are forwarded to the dual distance terminal after the switching is completed, thereby preventing data for the dual distance terminal from lost during the switching.

2.3 Switching From One Short Distance Communication Network to Another Short Distance Communication Network

When the dual distance terminal moves from one short distance cell to another short distance cell, the dual distance terminal identifies the short distance AP to which it will enter, and sends the cell information to the dual distance network server, thereby implementing the switching between the short distance cells. The dual distance terminal then informs the home server among the dual distance network servers that it has already entered in the area covered by another short distance communication network, and the home server is in charge of the query and communication to it from the other terminals in the network.

2.4 Automatic Switching

The subscriber may define the priority level of the switching in advance if necessary so that the dual distance terminal may perform automatic switching. The priority level is set according to charging fee, transmission rates, quality stability and the likes, for example. The dual distance terminal automatically identifies the switching according to the priority level. Further, when the subscriber is located within the areas covered by short distance AP, it may not select the use of short distance AP, but may directly select the use of long distance communication.

3. Scanning and Detecting

With respect to the long and short distance communication network architecture, the most important problems are as follows:
(1) the dual distance terminal keeps the long distance and the short distance radio frequency entity in operating state all the time, and detects the possible long distance or short distance communication network environment in real-time, continuously feeds the detected results back to the dual distance terminal switching management mechanism, the detected results are reported to the dual distance network server through the existing network periodically or as desired;
(2) the dual distance termnal keeps the radio frequency function entity in the network in which it locates in operating state all the time, and activates the corresponding radio frequency function entities for the other networks periodically or non-periodically to detect the candidate networks;
(3) The dual distance terminal may keeps the radio frequency function entity in the network in which it locates in operating state all the time, and does not scan and detect the other networks. In this case, the dual distance terminal detects the other networks only when the existing network is not available;

The detection for candidate networks with non-periodically activating the corresponding radio frequency function entity may be carried out by means of some specific algorithms, such as a viable-step detection method which the time interval of finally finding the occurrence of other networks is used as a function.

4. Switching Conditions

The switching conditions can be selected according to different situations for the network user, hereafter is the two examples of the switching conditions. It should be noted that the present invention did not limit the two switching conditions as described below, other conditions can also be used in the present invention.
(1) The network switching Is performed based on priority level. That is, as long as the dual distance terminal finds the occurrence of the network with higher priority level, then it switches to the network with higher priority level, no matter whether the network which is used currently is available or not. The subscribers can define the priority levels of various wireless networks as desired, for example, transmission rate, usage fee and the likes.
(2) The dual distance terminal switches to other networks only when the currently used wireless network signals may not be received. This switching condition means that the switch is performed only when the wireless network in which the dual distance terminal currently locates is not available. In contrary, the switch is not performed if the network in which the dual distance locates is available, even though there is a network with a higher priority level.

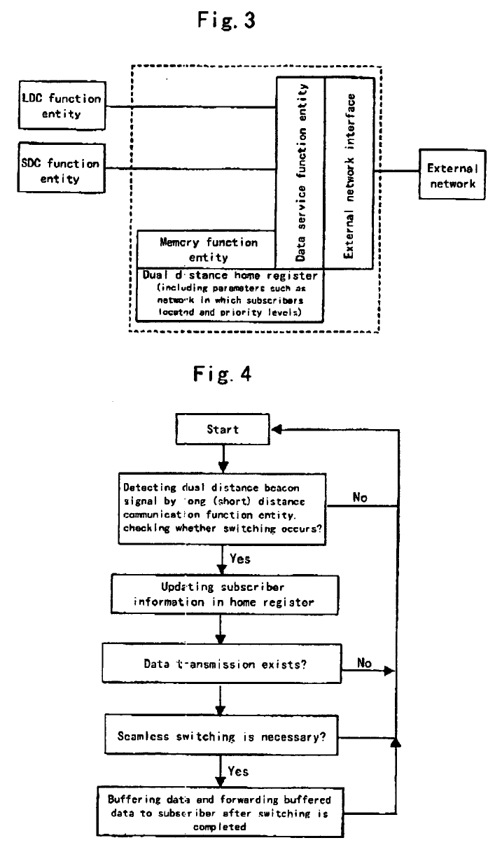

FIG. 3 is a schematic diagram showing the dual distance network server. The dual distance network server comprises a data service function entity, a memory function entity, a dual distance home server, and an external network interface. The data service function entity detects whether a long or short distance data transmission occurs. The data transmission includes data transmission between the dual distance terminal located in a long distance communication network and the dual distance terminal located in a short distance communication network, and the data transmission between the dual distance terminal located In a long or a short distance communication network and external networks. The data transmission between the dual distance terminals located in a long (or short) distance communication network can be carried out by the long (or short) distance network function entity (provided in the dual distance network server, not shown). When a long and a short distance data transmission occurs, a connection service is provided to the data transmission.

A beacon signal of the dual distance terminal forwarded by the long (short) distance network function entity is detected to determine whether the dual distance terminal performs a switching between the long and short distance communication networks. If so, then a new terminal information (for example, a network name to which the terminal is switched) is informed to a dual distance home register.

The memory function entity stores the data which is possibly missed at the time of switching. Further, the memory function entity forwards the stored data to the terminal via the data service function entity after the switching is completed so that the terminal can achieve a seamless switching between the long distance communication network and the short distance communication network.

The dual distance home server records the dual distance characteristic parameters of the managed dual distance terminals, such as the situations of the located network, priority level parameters of the terminals and the likes. The terminal switching information Can be obtained via the data service function entity when a switching occurs between the long distance communication network and the short distance communication network. The terminal data Is updated. The terminal-related dual distance information is Informed to the data service function entity when a query regarding the terminal occurs.

The external network inter-face connects the long distance communication network and short distance communication network to the external network. The external network interface comprises a wireless interface, an interface for wire network, and an interface for other wireless networks.

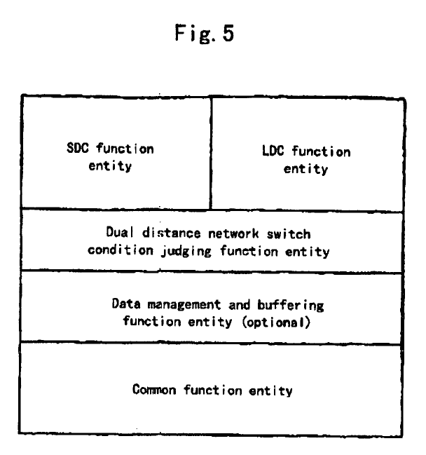

FIG. 4 is a flow chart showing the operation process when the dual network server performs switching. When the dual distance terminal moves from one network to another network, the dual distance network server cooperates with the dual distance terminal for performing switch. The process of the switching Is as follows:
first step: detecting the dual distance beacon signal of the dual distance terminal by the long (or short) distance network function entity, checking whether a switching occurs, if it is not, then the detection is repeated; if it is yes, the flow turns to next step;
second step: updating the subscriber information registered in the dual distance home register;
third step: determining whether or not data transmission occurs, if it is not, the flow returns to the first step;
fourth step: determining whether or not there exist a need for seamless switching, if it is not, the flow returns to the fist step;
fifth step: buffering the transmitted data, and forwarding the buffered data to the dual distance terminal after the switch is completed.

FIG. 5 is a schematic diagram showing the functional structure of the dual distance terminals according to an embodiment of the invention. The dual distance terminal according to the present invention can operate within the long distance communication network and the short distance communication network during it moves in both networks. Therefore, it is necessary for the dual distance terminals of the invention to have a structure adaptive to the features of both networks. The dual distance terminal comprises at least a short distance communication function entity, a long distance communication function entity, a dual network switch condition judging function entity, and a common function entity.

The short distance communication function entity includes a short distance radio frequency function module and may achieve the functions of the physical layer and a part of a MAC layer or link layer. The short distance communication function entity operates in the short distance communication network and obtains data information.

The long distance communication function entity Includes a long distance radio frequency function module and may achieve the functions the physical layer and a part of link layer.

The network switch condition judging function entity performs network switching for the dual distance terminal based on the corresponding dual distance switch condition judging and instructs the short distance communication function entity or the long distance communication function entity to send a beacon signal to the dual distance network server;

The common function entity includes basic functions such as display, input and output contained in conventional terminals;

The dual distance terminal controls the operating modes of the radio frequency function module in the long (short) communication function entity by using the dual network switch condition judging function entity. The operating modes of the radio frequency function modules comprise (1) the long radio frequency function module and short radio frequency function module operate simultaneously; (2) performs the viable-step operating mode according to circumstances; and (3) only when one network does not exist, the radio frequency function entity corresponding to the other network is activated so as to search for the other network.

In the present invention, alternatively, the dual distance terminal may also comprise a data management and buffering function entity which manages and buffers the corresponding data during the switching.

Unlike the conventional terminals, the dual distance terminal of the invention has both the long distance and the short distance communication function entity. Therefore, it can detect or automatically search the possible short distance communication networks such as WLAN and the long distance communication networks such as GSM/GPRS or 3G simultaneously. Further, it can also perform the short distance or long distance data transmission services (including voice which is a specific data service) by means of the short distance and the long distance function entities. Another difference from the conventional terminals is in that the dual distance terminal of the invention also comprises a network switch condition judging function entity. The network switch condition judging function entity performs network switching for the dual distance terminal based on the corresponding dual distance switch condition judging and instructs the short distance communication function entity or the long distance communication function entity to send a beacon signal to the dual distance network server. Further, it may optionally comprise a data management and buffering function entity which manages and buffers the corresponding data during the switching. Thus, the data transmission requested by the common function entity does not be interrupted due to the switching.

Although the present Invention has been described by way of exemplary embodiments, it should be understood that many changes and substitutions may further be made by those skilled In the art without departing from the scope of the present invention which is defined by the appended claims.

1. A combined long and short distance wireless communication system comprising:
a dual distance terminal for providing subscribers with long and short distance communication services;
at least one remote distance base station for providing remote distance wireless access for said dual distance terminal;
at least one short distance access point (AP) for providing short distance wireless access for said dual distance terminal; and
a dual distance network server for connecting said at least one remote distance base station and said at least one short distance AP to execute network switching for said dual distance terminal and enabling said dual distance terminal to access the network to which it is switched, storing data that may be missed during switching and sending the stored data to said dual distance terminal after said terminal switching is completed.

2-3. (Canceled)

4. A dual distance server used for a combined long and short distance wireless communication system as claimed in claim 1, comprising:
a data service function entity for detecting whether or not the occurrence of a long and short distance data transmission is, if it is, then providing a connection service for said data transmission;
a memory function entity for storing data that may be missed during switching, and sending the stored data to a dual distance terminal via said data service function entity after said network switching is completed;
a dual distance home server for registering the dual distance communication parameters of the dominated dual distance terminals, obtaining network switch information via said data service function entity in the case where dual distance switch occurs, updating data of the dual distance terminal, and informing said data service function entity of dual distance terminal information when a query regarding the terminal exists; and
an external network interface unit for connecting dual distance network and an interface of an external network.

5. The dual distance server according to claim 4, wherein said external network interface comprises a wireless interface, an interface for wire network, and an interface for other wireless networks.

6. A dual distance terminal used for a combined long and short distance wireless communication system as claimed in claim 1, comprising:
a short distance communication function entity having a short distance radio frequency function module for functioning as physical layer, part of MAC layer or link layer and operating in a short distance communication network to obtain data information;
a long distance communication function entity having a long distance radio frequency function module for functioning as physical layer and part of link layer;
a network switch condition judging function entity for performing network switching for the dual distance terminal based on the dual distance switch condition and instructing the short distance communication function entity or the long distance communication function entity to send a beacon signal to the dual distance network server;
a data management and buffering function entity for storing data that may be missed during switching and sending the stored data to a common function entity in the high level of the dual distance terminal after said network switching is completed; and
a common function entity for implementing display, input and output functions of the terminal.

7. (Canceled)

8. A wireless communication method using combined long and short distance wireless communication systems, comprising steps:
detecting a dual distance terminal to determine whether it is located in a service area covered by a short distance access point;
entering a short distance communication network through the short distance access point in the case where the dual distance terminal is located within the service area covered by the short distance access point, and informing a dual distance home server of the position of the dual distance terminal;
searching for a base station for a long distance communication service if the dual distance terminal is not located in the area covered by any one of the short distance access points, entering a long distance communication network through a base station for a long distance communication service, and informing the dual distance home server of the position of the dual distance terminal;
switching between a long distance communication network and a short distance communication network when the dual distance terminal enters the short distance network service area from the long distance network service area, or enters the long distance network service area from the short distance network service area, and
storing data that may be missed during switching, and sending the stored data to a dual distance terminal via said data service function entity after said network switching is completed.

9. The wireless communication method according to claim 8, further comprising the step of when the dual distance terminal detects that a wireless local area network (WLAN) exists in the short distance network, the dual distance terminal then accesses the WLAN network; the dual distance terminal continues the detection and enters into the long distance network in the case where the entrance into the WALN network is unsuccessful.

10. The wireless communication method according to claim 9, further comprising the step of the dual distance terminal performs data transmission by accessing the dual distance server via the short distance WLAN network in the case where the dual distance terminal enters into the short distance WLAN network.

11. The wireless communication method according to claim 9, further comprising the step of the dual distance terminal terminates data transmission through a short distance radio frequency function entity and activates a long distance communication function entity and performs the sequent data transmission if a predetermined threshold for the switching is satisfied during the dual distance terminal moves out of the short distance WLAN network and enters into the long distance network so that network switch is completed.

12. The wireless communication method according to claim 11, wherein the predetermined threshold for the switching is a non-usable threshold of a short distance network signal or a non-optimal threshold of a short distance network signal.

13. The wireless communication method according to claim 11, further comprises the steps of in the case where the dual distance terminal requests seamless switching from the short distance network to the long distance network based on its service level, the dual distance terminal terminates data transmission through the short distance radio frequency function entity the dual distance terminal and sends a beacon signal to the short distance AP from which is switched through the short distance communication function entity in the terminal, the beacon signal is then transmitted to the dual distance network server by the short distance AP, the dual distance network server informs the long distance communication function entity to be accessed by the dual distance terminal of the receipt, and determines the service queue position which the dual distance terminal is arranged in the long distance network function entity based on its service level.

14. (Canceled)

15. The wireless communication method according to claim 8, further comprise the step of the dual distance terminal terminates data transmission through a long distance radio frequency function entity and activates a short distance communication function entity and performs the sequent data transmission if a predetermined threshold for the switching is satisfied during the dual distance terminal moves out of the long distance WLAN network and enters into the short distance network so that network switch is completed.

16. The wireless communication method according to claim 15, further comprises the steps of in the case where the dual distance terminal requests seamless switching from the long distance network to the short distance WLAN network based on its service level, the dual distance terminal terminates data transmission through the long distance radio frequency function entity and sends a beacon signal to the long distance network function entity from which is switched through the long distance communication function entity in the terminal, the beacon signal is then transmitted to the dual distance network server by the lone distance communication function entity, the dual distance network server informs the short distance communication function entity to be accessed by the dual distance terminal of the receipt, and determines the service queue position which the dual distance terminal is arranged in the short distance network function entity based on its service level.

17. (Canceled)

18. The wireless communication method according to claim 9, further comprises the step of when the dual distance terminal moves from one short distance cell to another short distance cell, the dual distance terminal identifies the short distance access point to which it enters, and sends the cell information to the dual distance network server to perform the switching between the short distance cells.

19. The wireless communication method according to claim 18, further comprises when the dual distance terminal moves from one short distance cell to another short distance cell, the dual distance terminal informs the home server among the dual distance network servers that it has already entered in said another short distance cell, and the home server manages the query and communication to it from the other terminals in the network.

20. (Canceled)

21. The wireless communication method according to claim 31, wherein the detection for candidate networks with non-periodically activating the corresponding radio frequency function entity is carried out by using a viable-step detection method which the time interval of finally finding the occurrence of other networks is used as a function.

22-26. (Canceled)

27. The wireless communication method according to claim 8, wherein the process of the dual distance server cooperating with the dual distance terminal to perform the switch comprises:
first step: detecting the dual distance beacon signal of the dual distance terminal by the long (or short) distance network function entity to determine whether or not a switching occurs;
second step: updating the subscriber information registered in the dual distance home register;
third step: determining whether or not data transmission occurs, if it is not, the flow process returns to the first step;
fourth step: determining whether or not there exists a need for seamless switching, if it is not, the process returns to the fist step;
fifth step: buffering the transmitted data, and forwarding the buffered data to the dual distance terminal after the switch is completed.

28. The wireless communication method according to claim 15, wherein when the dual distance terminal located in the long distance network requests to enter any one of the service areas covered by the short distance access points, and the dual distance terminal can not access the short distance network, then the dual distance terminal still operates the long distance communication.

29. The wireless communication method according to claim 8, wherein the subscriber defines the priority levels of the switching in advance as desired so that the dual distance terminal performs automatic switching.

30. The wireless communication method according to claim 8, wherein said step of detecting a dual distance terminal to determine whether it is located in a service area covered by a short distance access point further comprises:
the dual distance terminal keeps the long distance and the short distance radio frequency entity in operating state, and detects the long distance or short distance communication network environment in real-time, feeds the detected results back to the dual distance terminal switching management mechanism, reports the detected results to the dual distance network server through the existing network periodically or as desired.

31. The wireless communication method according to claim 8, wherein said step of detecting a dual distance terminal to determine whether it is located in a service area covered by a short distance access point further comprises:
the dual distance terminal keeps the radio frequency function entity corresponding to the network in which it locates in operating state, and activates the radio frequency function entities for the other networks periodically or non-periodically to detect the candidate networks.

32. The wireless communication method according to claim 8, wherein said step of detecting a dual distance terminal to determine whether it is located in a service area covered by a short distance access point further comprises:
the dual distance terminal keeps the radio frequency function entity corresponding to the network in which it locates in operating state, and does not detect the other networks until the existing network is not available.

33. The wireless communication method according to claim 8, wherein said predetermined conditions for the switching refers to switch the dual distance terminal to a network with higher priority level in the case where the network with higher priority level exists.

34. The wireless communication method according to claim 8, wherein said predetermined conditions for the switching refers to switch dual distance terminal to other networks only when the currently used wireless network signals can not be received.

35. The wireless communication method according to claim 11, wherein said predetermined conditions for the switching refers to switch the dual distance terminal to a network with higher priority level in the case where the network with higher priority level exists.

36. The wireless communication method according to claim 11, wherein said predetermined conditions for the switching refers to switch dual distance terminal to other networks only when the currently used wireless network signals can not be received.

37. The wireless communication method according to claim 13, wherein said predetermined conditions for the switching refers to switch the dual distance terminal to a network with higher priority level in the case where the network with higher priority level exists.

38. The wireless communication method according to claim 13, wherein said predetermined conditions for the switching refers to switch dual distance terminal to other networks only when the currently used wireless network signals can not be received.
